(19) United States
(12) Patent Application Publication
(10) Pub. No.: US 2025/0196421 A1
(43) Pub. Date: Jun. 19, 2025

(54) CONVEYOR SYSTEM, MANUFACTURING SYSTEM, AND A METHOD OF MANUFACTURE

(71) Applicant: Lear Corporation, Southfield, MI (US)

(72) Inventors: David Hale, Northville, MI (US); Joshua Hallock, Warren, MI (US)

(21) Appl. No.: 18/968,341

(22) Filed: Dec. 4, 2024

Related U.S. Application Data
(60) Provisional application No. 63/610,806, filed on Dec. 15, 2023.

(30) Foreign Application Priority Data
Jul. 18, 2024 (DK) PA202470197

(51) Int. Cl. B29C 48/355; B29C 48/00; B29C 48/88; B29L 31/58; B65G 17/06; B65G 17/26

(52) U.S. Cl. CPC B29C 48/355; B29C 48/022; B29C 48/911; B29C 48/919; B65G 17/067; B65G 17/26; B29L 2031/58; B65G 2811/095

(57) ABSTRACT

A system includes a die, a first conveyor, and a second conveyor. The die is operable to form a product from molten material. The first and second spaced-apart conveyors each comprise plates extending between opposing lateral sides of the first and second spaced-apart conveyors. The plates (i) are operable to engage and pull the formed product away from the die and (ii) at least a subset of the plates comprise an elasticity such that at least the subset of the plates expand and conform to an outer contour of the formed product.

### CROSS-REFERENCE TO RELATED APPLICATIONS

This application claims the benefit of U.S. provisional application Ser. No. 63/610,806, filed Dec. 15, 2023, and priority to Denmark application Serial No. PA 2024 70197 filed Jul. 18, 2024, the disclosures of which are hereby incorporated in their entirety by reference herein.

### TECHNICAL FIELD

This relates to a conveyor system, a manufacturing system, and a method of manufacture.

### BRIEF DESCRIPTION OF THE DRAWINGS

FIG. 1 is a perspective view of an example of a seat assembly;

FIGS. 2A and 2B are a perspective front view and corresponding a magnified view, respectively, of an example of a cushion of the seat assembly that comprises a filament mesh structure;

FIG. 3 is schematic view of an example of a manufacturing system for making the filament mesh structure;

FIG. 4 is a schematic view a tractor conveyor of the manufacturing system that engages the filament mesh structure;

FIG. 5A-5C illustrate portions of a tractor plate of the tractor conveyor engaging a formed product and in various expanded states;

FIG. 6 is a partial perspective rear view of tractor conveyor;

FIG. 7 is a partial front view of the tractor conveyor;

FIG. 8 is a top view of a section of the tractor conveyor;

FIG. 9 is an alternative configuration for the tractor plates of the tractor conveyor; and

FIG. 10 is a flowchart of a method for forming and transporting the filament mesh structure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

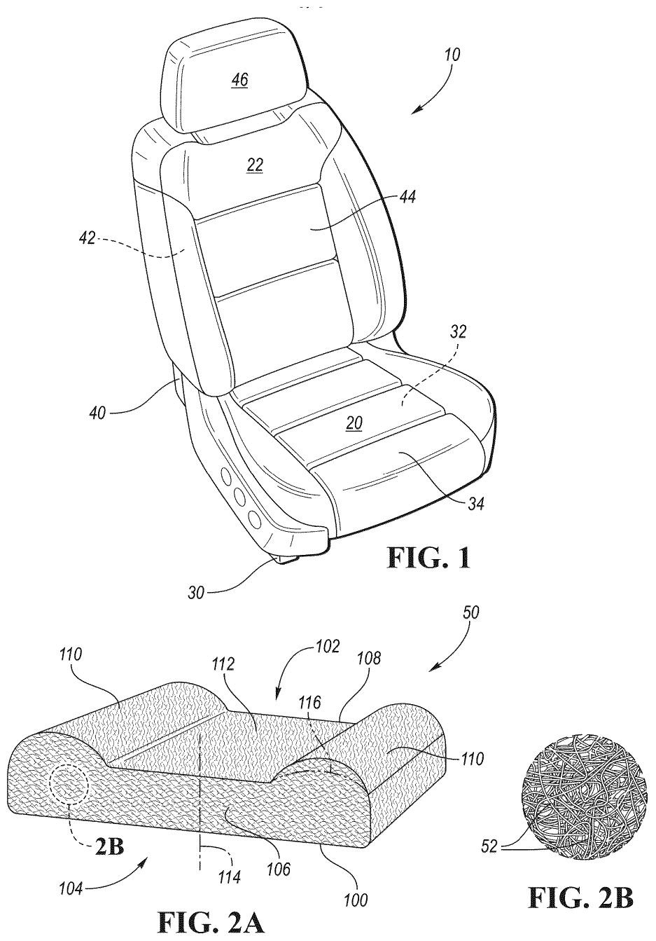

Referring to FIG. 1, an example of a seat assembly 10 is shown. In some embodiments, the seat assembly 10 is a vehicle seat assembly, such as for a land vehicle like a car, truck, bus, or the like, or for a non-land vehicle like aircraft or watercraft. For example, a seat assembly 10 for a land vehicle may be shaped and sized as a front row driver or passenger seat, a second, third, or other rear row seat, and may include bucket-style seats as shown, bench-style seats, or other seat styles. Furthermore, the seat assembly 10 may be a non-stowable seat or a stowable seat that may be foldable and stowable in a cavity in the vehicle floor. Additionally, the seat assembly 10 may be configured for non-vehicle applications such as furniture.

In the configuration shown in FIG. 1, the seat assembly 10 includes a seat bottom 20 and a seat back 22. It is contemplated that the seat back 22 may be omitted in some configurations, such as when the seat assembly 10 is configured as a motorcycle seat or stool.

The seat bottom 20 is configured to receive a seated occupant and support the pelvis and thighs of the seat occupant. The seat bottom 20 includes a seat bottom frame 30, a cushion 32, and a trim cover 34.

The seat bottom frame 30 is a structure that supports the cushion 32. The seat bottom frame 30 includes one or more structural members and may be made of any suitable material, such as a metal alloy, polymeric material, fiber reinforced polymeric material, or combinations thereof. In some configurations, the seat bottom frame 30 includes a panel, seat pan, suspension mat, or suspension wires upon which the cushion 32 is disposed.

The cushion 32 is disposed on the seat bottom frame 30. The cushion 32 is made of a compliant material that supports the seat occupant and distributes load forces from the seat occupant to the seat bottom frame 30. The cushion 32 and associated methods of manufacture will be discussed in more detail below.

The trim cover 34 covers at least a portion of the cushion 32. In addition, the trim cover 34 provides one or more visible exterior surfaces of the seat back 22. The seat occupant may be disposed on the trim cover 34 when seated upon the seat assembly 10. The trim cover 34 is made of any suitable material or materials, such as fabric, leather, leatherette, vinyl, or combinations thereof. The trim cover 34 may include a plurality of trim panels that are assembled in any suitable manner, such as by fusing or stitching. The trim cover 34 is attached to the seat bottom frame 30, the cushion 32, or both. For example, the trim cover 34 may include trim attachment features that are attached to the seat bottom frame 30, the cushion 32, or both, to inhibit removal of the trim cover 34 and help conform the trim cover 34 to the contour of the seat bottom frame 30, the cushion 32, or both.

The seat back 22 is configured to support the back of a seated occupant. The seat back 22 is disposed adjacent to the seat bottom 20. For example, the seat back 22 may be disposed above the seat bottom 20 and near the rear side of the seat bottom 20. The seat back 22 extends in a generally upward direction away from the seat bottom 20. In some configurations, the seat back 22 is mounted to the seat bottom 20 and may be pivotable with respect to the seat bottom 20. In other configurations, the seat back 22 is not mounted to the seat bottom 20. For instance, a vehicle seat back may be mounted to the vehicle body structure, such as in some second row seat assemblies. The seat back 22 includes a seat back frame 40, a cushion 42, a trim cover 44, and optionally a head restraint 46.

The seat back frame 40 is a structure that supports the cushion 42. The seat back frame 40 includes one or more structural members and may be made of any suitable material, such as a metal alloy, polymeric material, fiber reinforced polymeric material, or combinations thereof. In some configurations, the seat back frame 40 includes a panel, pan, suspension mat, or suspension wires upon which the cushion 42 is disposed. It is also contemplated that the seat back frame 40 may be integrally formed with the seat bottom frame 30.

The cushion 42 is disposed on the seat back frame 40. The cushion 42 is made of a compliant material that supports the seat occupant and distributes load forces from the seat occupant to the seat back frame 40. It is contemplated that the cushion 42 may be integrally formed with the cushion 32 of the seat bottom 20 or may be separate from the cushion 32 of the seat bottom 20. The cushion 42 and associated methods of manufacture will be discussed in more detail below.

The trim cover 44 covers at least a portion of the cushion 42. In addition, the trim cover 44 provides one or more visible exterior surfaces of the seat back 22. The seat occupant may be disposed on the trim cover 44 when seated upon the seat assembly 10. The trim cover 44 is made of any suitable material or materials, such as fabric, leather, leatherette, vinyl, or combinations thereof. The trim cover 44 may include a plurality of trim panels that are assembled in any suitable manner, such as by fusing or stitching. The trim cover 44 is attached to the seat back frame 40, the cushion 42, or both. For example, the trim cover 44 may include trim attachment features that are attached to the seat back frame 40, the cushion 42, or both, to inhibit removal of the trim cover 44 and help conform the trim cover 44 to the contour of the seat back frame 40, the cushion 42, or both.

The head restraint 46, if provided, is configured to support the head of a seat occupant. The head restraint 46 is disposed at the top of the seat back 22 or at an end of the seat back 22 that is disposed opposite the seat bottom 20. The head restraint 46 may be moveable in one or more directions with respect to the seat back 22 or may be integrally formed with the seat back 22.

Referring to FIG. 2, an example of a cushion 50 is shown. The cushion in generically designated with reference number 50 for convenience in reference. It is to be understood that the structure and description of the cushion 50 is applicable to the cushion 32 of the seat bottom 20, the cushion 42 of the seat back 22, or both.

The cushion 50 is a non-foam component or includes at least one non-foam component. The non-foam component is primarily referred to as a filament mesh structure but may also be referred to as a mesh cushion, mesh structure, or stranded mesh. In FIG. 2, the cushion 50 is depicted as a non-foam component that does not include a foam component or foam material, such as urethane or polyurethane foam; however, it is contemplated that the cushion 50 may also include a foam component or foam material in addition to a non-foam component to provide additional cushioning or localized cushioning for a seat occupant. For example, foam material may be provided between the cushion 50 and a trim cover (e.g., trim cover 34, 44) that is disposed on the cushion 50, within the cushion 50, or combinations thereof. Reducing the amount of foam material that is provided with the cushion 50 or eliminating foam material from the cushion 50 reduces weight, may improve support and comfort of a seat occupant, and may improve recyclability.

The cushion 50 is described below in the context of a cushion 50 that does not include foam material. In this context, the cushion 50 is made of filaments 52 of polymeric material that are randomly looped, bent, curled, or entangled and are bonded together as will be discussed in more detail below. A filament 52 is directed bonded to another filament 52 rather than being indirectly bonded with a resin or other intermediate material.

The filaments 52, which may also be referred to as strands or threads, is made of any suitable material or materials. In some configurations, the filaments 52 are made of a thermoplastic material or thermoplastic material, such as a thermoplastic resin that is polyamide-based, polyester-based, polyimide-based, polyolefin-based, polypropylene-based, polystyrene-based, or combinations thereof. As one example, a polyethylene-based filament may be made of linear low density polyethylene (LLPDE). The filament material may be recyclable unlike foam material or more easily recycled than foam material. It is also contemplated that a filament 52 may comprise reinforcement fibers and that the reinforcement fibers may not be made of a thermoplastic material.

In some configurations, a filament 52 may be a monofilament that is made of a single material. In some configurations, a filament 52 is made of multiple materials. As an example, a filament 52 made of multiple materials may include a core that is made of a first thermoplastic material and a sheath that encircles the core and is made of a second thermoplastic material that differs from the first thermoplastic material. It is contemplated that the cushion 50 may include a combination of monofilaments and filaments that are made of multiple materials and are not monofilaments.

Filaments 52 that are randomly looped, bent, looped, curled, or entangled are bonded together where one filament 52 contacts another filament 52, thereby resulting in a lightweight, air permeable cushion (e.g., cushion 32 and/or 42) or mesh structure comprising a set of filaments 52 having openings or voids between the filaments 52.

The cushion 50 is a manufactured product that comprises a filament mesh structure or body comprising a set of the filaments 52. A cross cross-sectional contour 100 of the cushion 50 comprises a first region 102 and a second region 104. The cross-sectional contour 100 may comprise the outer periphery of the cushion 50 taken along the front end 106 of the cushion 50, the back end 108 of the cushion 50, or any cross-section between the front end 106 and back end 108 of the cushion 50. Such a cross-section between the front end 106 and back end 108 of the cushion 50 may be substantially parallel to either the front end 106 or back end 108 of the cushion 50. Substantially parallel may refer to any range of values that is between exactly parallel and 20° or less from exactly parallel. For example, substantially parallel may refer to a value between 20° and exactly parallel, 15° and exactly parallel, 10° and exactly parallel, 5° and exactly parallel, 1° and exactly parallel, etc.

The first region 102 may be a top region or top surface of the cushion 50 while the second region 104 may be a bottom region or bottom surface of the cushion 50. The first region 102 may include a pair of spaced-apart protrusions 110. The spaced-apart protrusions 110 may comprise or form side bolsters of either a seat bottom 20 or a seat back 22. The spaced-apart protrusions 110 may extend from a centrally positioned region 112 within the first region 102. The centrally positioned region 112 may comprise a substantially flat or substantially planar region or surface. The second region 104 may also comprise a substantially flat or substantially planar region or surface.

Substantially flat or substantially planar may refer to a flat or planar surface that has no deviations from a perfectly flat plane or has deviations from the perfectly flat plane that are less than a tolerance of 10 millimeters (mm). For example, the centrally positioned region 112 may have an allowable tolerance of 10 mm or less, 5 mm or less, 2 mm or less, 1 mm or less, or 0.5 mm or less, 0.25 mm or less, etc. from a corresponding perfectly flat plane.

If the cushion 50 is utilized as cushion 32 of the seat bottom 20, the cushion 50 may be secured to the seat bottom frame 30 such that the spaced-apart protrusions 110 extend away or upward from the seat bottom frame 30. If the cushion 50 is utilized as cushion 42 of the seat back 22, the cushion 50 may be secured to the seat back frame 40 such that the spaced-apart protrusions 110 extend away or forward from the seat back frame 40. The cushion 50 may be symmetrical along central axis 114. For example, the front end 106 of the cushion 50, the back end 108 of the cushion 50, or any cross-section between the front end 106 and back end 108 of the cushion 50 may be symmetrical along central axis 114 such that left and right sides of the front end 106 of the cushion 50, the back end 108 of the cushion 50, or any cross-section between the front end 106 and back end 108 of the cushion 50 are mirror images of each other. Alternatively, the cushion 50 may not be symmetrical along central axis 114. For example, one of the spaced-apart protrusions 110 may be smaller than the other of the spaced-apart protrusions 110 in the event asymmetrical side bolsters of either seat bottom 20 or seat back 22 are desired. Phantom line 116 illustrates a scenario where one of the spaced-apart protrusions 110 is shorter or smaller than the other of the spaced-apart protrusions 110 (e.g., one of the spaced-apart protrusions 110 extends a shorter distance away from the centrally positioned region 112 relative to the other of the spaced-apart protrusions 110).

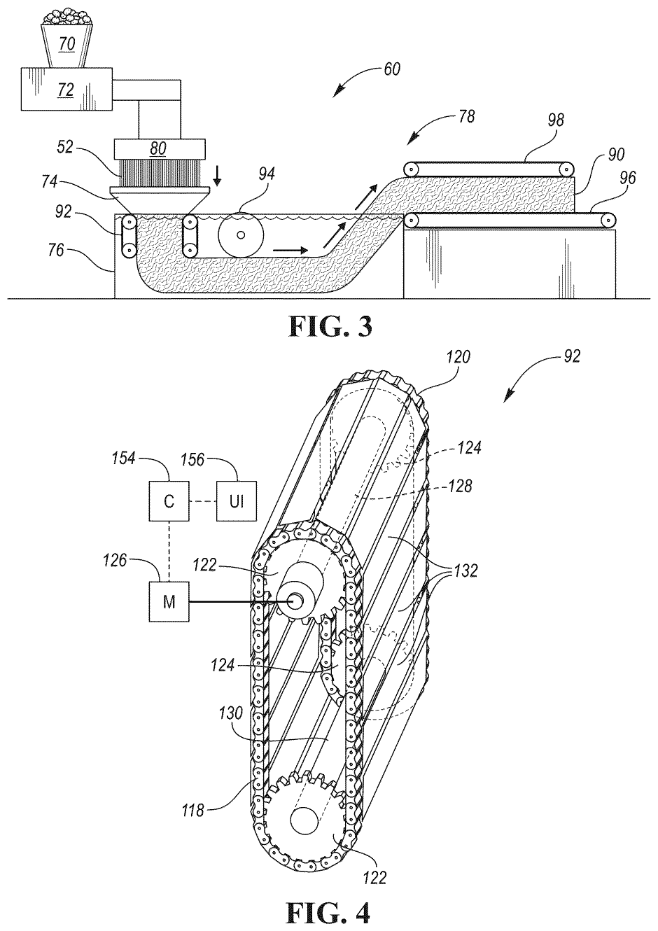

An example of a manufacturing system 60 of making a cushion or filament mesh structure (e.g., cushion 50) is also shown in FIG. 3. In this example, the manufacturing system 60 includes a material supply 70, an extruder 72, and a funnel 74. The manufacturing system 60 also includes a fluid or cooling tank 76 and a material handling subsystem 78.

Referring to FIG. 3, the material supply 70 holds material stock that is to be extruded, such as solid beads, flakes, granules, pellets, or powder made of the material. In some configurations, the material supply 70 is configured as a container or hopper. The material supply 70 provides material stock to the extruder 72.

The extruder 72, which may also be referred to as a first tool, melts the material stock and extrudes the material stock into a set of filaments 52. The extruder 72 may have any suitable configuration. In some configurations, the extruder 72 includes a barrel that receives a rotatable screw and heating elements. Rotation of the screw forces the material to move through the barrel and helps heat the material due to the friction generated as the screw rotates. The material exits the barrel under pressure and in a molten state and is transported to a die 80 of the extruder 72.

The die 80, which may also be referred to as a die plate or extrusion die, has multiple through holes or filament forming openings through which the molten material passes. A single filament 52 is extruded from each through hole. The filaments 52 fall downward from the die 80 under the force of gravity into the funnel 74.

The funnel 74 consolidates or groups the filaments 52 into a more compact arrangement in which the filaments bend, curl, or loop and each filament 52 contacts and bonds to at least one other filament 52. The funnel 74 has an inlet opening or funnel inlet and an outlet opening or funnel outlet that is smaller than the funnel inlet. Individual separated filaments 52 enter the funnel inlet. The filaments 52 bend, curl, or loop and move into contact as they accumulate. The filaments 52 move through the funnel 74 toward the funnel outlet. Some filaments may slide along the funnel 74 or an intervening sheet that is disposed on the funnel 74 as the filaments move toward the funnel outlet. Bonds are formed between filaments 52 at the points of contact while openings or voids between filaments 52 are present at other locations where one filament 52 does not contact or bond to another filament 52. The entangled and bonded filaments 52 pass through the funnel outlet of the funnel 74 and enter the cooling tank 76. For convenience in reference, the bonded filaments 52 are referred to as a filament mesh structure 90. The funnel 74 may be a die or may operate as a die that to form a product (e.g., the filament mesh structure 90) from molten material (e.g., the filaments 52 in a molten state).

The cooling tank 76 holds a liquid, such as water or a mixture of water and another fluid. The liquid in the cooling tank 76 helps support the entangled and bonded filaments 52 to limit further compacting or consolidation of the filaments 52 into a less open or less porous arrangement and maintains a desired porosity and density of the filament mesh structure 90. Thus, the liquid provides some buoyancy or resistance that can result in additional bending, curling, or looping of the filaments 52 adjacent to the surface of the liquid or within the funnel 74 to further build the filament mesh structure 90. The liquid also cools the filaments 52 when the filaments 52 are in the liquid. For instance, the liquid cools the filaments 52 from the outside to solidify the filaments 52 and prevent the filaments from bonding at additional locations. At this point, the filaments 52 are relatively stiff and no longer in a plastic state and thus generally maintain a shape and are not moldable or reformable without being reheated.

The material handling subsystem 78 transports the filament mesh structure 90 through the cooling tank 76. The material handling subsystem 78 includes various rollers and conveyors that help move the filament mesh structure 90 through the liquid and out of the liquid. In some configurations, one or more conveyors, tractors, or tractor conveyors 92 are provided in the cooling tank 76 to help pull the filament mesh structure 90 away from the funnel 74 and into the cooling tank 76, and to counter buoyancy of the filaments 52. More specifically, the one or more tractor conveyors 92 may include first and second spaced-apart tractor conveyors 92, where the first and second spaced-apart tractor conveyors 92 are disposed on opposing or opposite sides of the filament mesh structure 90, and are configured to engage the opposing side of the filament mesh structure 90 to help pull the filament mesh structure 90 away from the funnel 74 and into the cooling tank 76.

One or more other rollers, such as roller 94, keep the filament mesh structure 90 submerged in the liquid and guide the filament mesh structure 90 through the cooling tank 76. For example, the roller 94 may guide the filament mesh structure 90 toward a conveyor belt 96 and shaker table 98 that are disposed outside of the cooling tank 76. The shaker table 98 shakes the filament mesh structure 90 while it is on the conveyor belt 96 to remove liquid. Alternatively or in addition, the filament mesh structure 90 may be squeezed to remove liquid, air may be blown toward the filament mesh structure 90 to help remove liquid, the filament mesh structure 90, or both. It is also contemplated that the filament mesh structure 90 may also be allowed to drip dry, or dry in ambient air.

The manufacturing system 60 described above is a continuous flow process in which the filament mesh structure 90 is formed as a continuous structure when filament extrusion is not interrupted. Further processing of the filament mesh structure 90 is provided after exiting the cooling tank 76 to cut the filament mesh structure 90 into individual pieces or blanks for individual cushions. Such processing is conducted by a cutting subsystem of the manufacturing system 60. The cutting system may be of any suitable type. For instance, the cutting system may employ a blade, knife, hot knife, saw, fluid jet, or the like to cut the filaments 52 of the filament mesh structure 90 into a blank. The cutting system may be used to shape or contour the blank. It is also contemplated that a blank may be further shaped or contoured with other manufacturing processes, such as molding of the entire blank or a portion thereof.

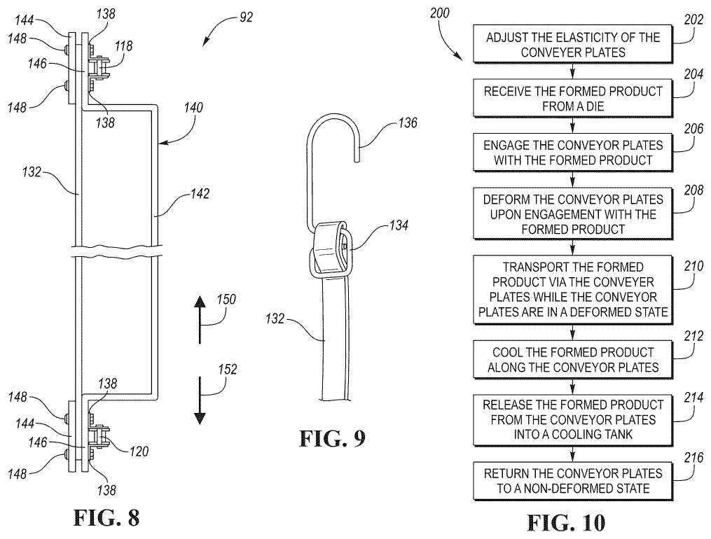

Referring to FIGS. 4-9, one of the tractor conveyors 92 and elements of the tractor conveyors 92 are illustrated in further detail. Each of the tractor conveyers 92 may include first and second spaced-apart carriers 118, 120, where the first carrier 118 and the second carrier 120 are disposed along opposing or opposite lateral sides of a respective tractor conveyer 92. The first carrier 118 may be moveable along one or more first drives 122. The second carrier 120 may be moveable along one or more second drives 124. The first and second carriers 118, 120 may be belts, chains, etc. that are moveable along a closed loop between at least two drives 122, 124, respectively. The one or more first drives 122 and the one or more second drives 124 may be pulleys, gears, rollers, sprockets, etc. At least one of the first drives 122 or one of the second drives 124 are rotated by a power source 126, such as an electric motor. The power source 126 may be connected several of the drives (e.g., the first drives 122 and the second drives 124). For example, the power source 126 may be connected to a first of the first drives 122 and a first of the second drives 124 that forms a first opposing pair of drives, which may in turn be connected to each other via a shaft 128. A second of the first drives 122 and a second of the second drives 124 may form a second opposing pair of drives that may in turn be connected to each other via shaft 130. The second opposing pair of drives may or may not be connected to the power source 126 in addition to the first opposing pair of drives. The second opposing pair of drives may be connected to the power source 126 in lieu of to the first opposing pair of drives.

The tractor conveyors 92 may include a plurality of flexible or resilient bands, straps, or plates 132. Each plate 132 may extend between opposing lateral sides of a respective tractor conveyor 92. More specifically, each plate 132 may extending between, and may be secured to each of, the first and second spaced-apart carriers 118, 120 of the respective tractor conveyor 92. Each of plates 132 are configured or operable to engage and transport a formed product. For example, each of the plates 132 may be operable to engage the filament mesh structure 90 and pull the filament mesh structure 90 away from the funnel 74 and into the cooling tank 76.

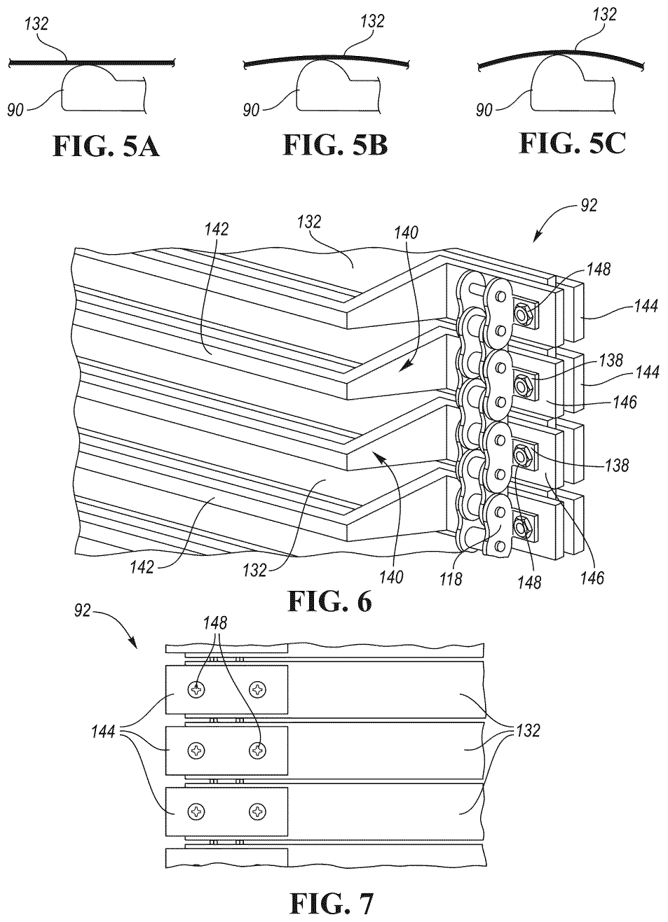

The plates 132, or at least a subset of the plurality of plates 132, have or comprise an elasticity that is greater than an elasticity of the formed product (e.g., the filament mesh structure 90) such that the plates 132 (or at least a subset of the plurality of plates 132) expand and conform to an outer contour of the formed product (e.g., the outer contour of the mesh structure 90, which may correspond to the cross cross-sectional contour 100 of the cushion 50 illustrated in FIG. 2A) in response to engagement between the formed product (e.g., the mesh structure 90) and the plates 132 (or at least a subset of the plurality of plates 132). The relative elasticity between the plates 132 and a portion of the mesh structure 90 is illustrative in FIGS. 5A-5C. As the mesh structure 90 is pushed further into one of the plates 132, or as a force between the mesh structure 90 and one of the plates 132 increases from 5A to 5B and then to 5C, the plate 132 flexes to accommodate the force between the mesh structure 90 and the plate 132 while the shape of the mesh structure 90 remains unchanged or has a small relative change due to the force when compared to the plate 132.

In some scenarios, the elasticity of the mesh structure 90 may be greater than or equal to the elasticity of the plates 132. However, in such scenarios, the plates 132 may be sufficiently elastic so that the plates 132 will still expand in response to an engagement between the mesh structure and the plates 132.

The elasticity of the plates 132 (or at least a subset of the plurality of plates 132) may be adjustable. For example, each plate 132 may engage a series of loops or a buckle 134 and may be adjustable along the corresponding buckle 134 to adjust the elasticity of the plates 132. Each plate 132 may be tightened on the buckle 134 to increase the tension of the plates 132, which in turn decreases the elasticity of the plates 132. Each plate 132 may also be loosened on the buckle 134 to decrease the tension of the plates 132, which in turn increases the elasticity of the plates 132. Hooks 136 may extend from the buckles 134 that may be utilized to secure the plates 132 to the first and second carriers 118, 120.

Alternative to the hooks 136, tabs 138 may extending from the first and second carriers 118, 120, and each plate 132 may be secured to at least one of one of the tabs 138 positioned on the first carrier 118 and to at least one of the tabs 138 positioned on the second carrier 120.

The tractor conveyors 92 may also include a plurality of brackets or stabilizer bars 140. Each stabilizer bar 140 extends between and is secured to the first and second carriers 118, 120. More specifically each stabilizer bar 140 may be secured to one of the tabs 138 positioned on the first carrier 118 and to one of the tabs 138 positioned on the second carrier 120. The stabilizer bars 140 provide rigidity and stability to the tractor conveyors 92, which prevents the first and second carriers 118, 120 from twisting or buckling. Each stabilizing bar 140 comprises a recessed central region 142 that is disposed between the carriers 118, 120 of the corresponding tractor conveyor 92. The recessed central regions 142 provide clearance for the plates 132 (or at least a subset of the plurality of plates 132) of the corresponding tractor conveyor 92 for when the plates 132 are in an expanded condition (e.g., FIGS. 5B a154nd 5C). The recessed central regions 142 may also provide space or clearance for the mesh structure 90 itself. For example, in a relaxed position the distance between the plates 132 on the two opposing tractor conveyors 92 that engage mesh structure 90 may be smaller than a width of the mesh structure 90.

Each stabilizer bar 140, each plate 132, and cover plates 144 may secured to the tabs 138. Each plate 132 may be sandwiched between two of the cover plates 144 and outer ends 146 of a stabilizer bar 140, while each stabilizer bar 140 may be sandwiched between the tabs 138 and the plates 132. Fasteners 148 may extend through the stabilizer bars 140, plates 132, cover plates 144, and tabs 138 to secure the stabilizer bars 140, plates 132, and cover plates 144 to the tabs 138. The fasteners 148 may comprise a bolt and nut combination. The stabilizer bars 140 and cover plates 144 operate as clamps to secure the position of the plates 132 on the first and second carriers 118, 120 once the fasteners 148 are tightened. The tension of the plates 132 may be increased to decrease the elasticity of the plates 132 or the tension of the plates 132 may be decreased to increase the elasticity of the plates 132 prior tightening the fasteners 148 and clamping the plates 132 in position between the stabilizer bars 140 and cover plates 144. More specifically, a laterally outward force may be applied or increased on the plates 132 (e.g., the plates 132 may be pulled or stretched laterally outward from the tractor conveyors 92 in opposing directions 150, 152) to increase the tension of the plates 132, which decreases the elasticity of the plates 132, or such a laterally outward force may be removed or decreased to decrease the tension of the plates 132, which increases the elasticity of the plates 132.

The fasteners 148 may extend through aligned apertures or orifices defined by the tabs 138, stabilizer bars 140, plates 132, and cover plates 144, to secure the stabilizer bars 140, plates 132, and cover plates 144 to the tabs 138 and ultimately to the first and second carriers 118, 120. The orifices defined by the plates 132 may be elongated slots to facilitate stretching or releasing tension on the plates 132 to increase and decrease the laterally outward force being applied to the plates 132, respectively, prior to clamping the plates 132 in position.

The power source 126, which may comprise one or more electric motors, are operable to activate the tractor conveyors 92, and the speeds of such one or more motors may be adjustable to increase or decrease the force of the plates 132 acting on the formed product (e.g., the mesh structure 90). For example, increasing the speed of the tractor conveyors 92 may increase the force of the plates 132 acting on the formed product while decreasing the speed of the tractor conveyors 92 may decrease the force of the plates 132 acting on the formed product. An operator may engage a user interface 156, which may include buttons, knobs, dials, switch touchscreens, etc., to adjust the speed of the one or more motors. More specifically, the user interface 156 may communicate with a controller 154, and controller 154 may adjust the speed of the one or more motors (e.g., power source 126) in response to an operator engaging the user interface 156.

While illustrated as one controller, the controller 154 may be part of a larger control system and may be controlled by various other controllers. It should therefore be understood that the controller 154 and one or more other controllers can collectively be referred to as a “controller.” The controller 154 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 154.

Control logic or functions performed by the controller 154 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based controller, such as controller 154. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer. The computer-readable storage devices or media may include one or more of a number of known physical devices which utilize electric, magnetic, and/or optical storage to keep executable instructions and associated calibration information, operating variables, and the like.

Referring to FIG. 10, a flowchart of a method 200 for forming and transporting a formed product (e.g., the mesh structure 90) is illustrated. The method 200 starts at block 202, were the elasticity of the conveyor plates 132 is adjusted prior to engaging the conveyor plates 132 with the formed product. Next, the method 200 moves on to block 204 where the tractor conveyors 92, or more specifically conveyor plates 132, receive the formed product (e.g., the mesh structure 90) from a die (e.g., the funnel 74) while the formed product is in a heated state. Next, the conveyer plates 132 engage the formed product at block 206. The conveyor plates 132 are then deformed (e.g., FIGS. 5B and 5C) at block 208 upon engagement with the formed product to conform to an outer contour (e.g., the cross cross-sectional contour 100 of the cushion 50) of the formed product. The formed product is then transported via the conveyor plates 132 while the conveyor plates 132 are in a deformed state at block 210. The formed product is then cooled along the conveyor plates at block 212 (e.g., the formed product is transported along the conveyor plates 132 within the cooling tank 76 where the formed product is cooled). Next, at block 214 the formed product is released from the conveyor plates 132 and into the cooling tank 76. The conveyor plates 132 are then returned to a non-deformed state (e.g., FIG. 5A) at block 216 upon the conveyor plates 132 releasing the formed product into the cooling tank 76.

It should be understood that the flowchart in FIG. 100 is for illustrative purposes and that the method 200 should not be construed as limited to the flowchart in FIG. 10. Some of the steps of the method 200 may be rearranged while others may be omitted entirely.

Clause 1. A tractor conveyor comprising: a first carrier movable along a first drive; a second carrier (i) movable along a second drive and (ii) spaced-apart from the first carrier; and a plurality of plates, each plate of the plurality of plates extending between each of the first and second carriers, the plurality of plates operable to engage and transport a formed product, and at least a subset of the plurality of plates comprising an elasticity such that at least the subset of the plurality of expand and conform to an outer contour of the formed product in response to engagement with the formed product.

Clause 2. The tractor conveyor of clause 1, wherein the elasticity of at least the subset of the plurality of plates is adjustable.

Clause 3. The tractor conveyor of any one of clauses 1 to 2 further comprising buckles, and wherein each plate of at least the subset of the plurality of plates engages one of the buckles.

Clause 4. The tractor conveyor of any one of clauses 1 to 3, wherein each plate of at least the subset of the plurality of plates is adjustable along a corresponding buckle to adjust the elasticity of the plates.

Clause 5. The tractor conveyor of any one of clauses 1 to 4 further comprising tabs extending from the first and second carriers, wherein each plate of the plurality of plates is secured to one of the tabs positioned on the first carrier and to one of the tabs positioned on the second carrier.

Clause 6. The tractor conveyor of clause 5 further comprising a plurality of brackets, wherein each bracket of the plurality of brackets extends between the first and second carriers, is secured to one of the tabs positioned on the first carrier, and is secured to one of the tabs positioned on the second carrier.

Clause 7. The tractor conveyor of clause 6, wherein each bracket of the plurality of brackets comprises a recessed central region that is (i) disposed between the first and second carriers and (ii) provides clearance for the plurality of plates when in an expanded condition.

Clause 8. A method comprising: engaging conveyor plates with a formed product; deforming the conveyor plates upon engagement with the formed product to conform to an outer contour of the formed product; and transporting the formed product via the conveyor plates while the conveyor plates are in a deformed state.

Clause 9. The method of clause 8 further comprising adjusting an elasticity of the conveyor plates prior to engaging the conveyor plates with the formed product.

Clause 10. The method of any one of clauses 8 to 9 further comprising cooling the formed product along the conveyor plates.

Clause 11. The method of any one of clauses 8 to 10 further comprising returning the conveyor plates to a non-deformed state upon the conveyor plates releasing the formed product.

Clause 12. The method of any one of clauses 8 to 11 wherein the formed product is released from the conveyor plates into a cooling tank.

Clause 13. The method of any one of clauses 8 to 12, wherein the conveyor plates receive the formed product from a die while the formed product is in a heated state.

Clause 14. The method of any one of clauses 8 to 14, wherein the elasticity of the conveyor plates is less than an elasticity of the formed product.

Clause 15. A system comprising: a die operable to form a product from molten material; and first and second spaced-apart conveyors each comprising plates extending between opposing lateral sides of the first and second spaced-apart conveyors, wherein the plates (i) are operable to engage and pull the formed product away from the die and (ii) at least a subset of the plates comprise an elasticity such that at least the subset of the plates expand and conform an outer contour of the formed product.

Clause 16. The system of clause 15, wherein the first and second spaced-apart conveyors comprise movable carriers disposed along the opposing lateral sides of the first and second spaced-apart conveyors.

Clause 17. The system of any one of clauses 14 to 16, wherein the plates of each of the first and second spaced-apart conveyors extend between and are secured to the carriers of the corresponding conveyor.

Clause 18. The system of any one of clauses 14 to 17 further comprising stabilizing bars secured to the movable carriers of each of the first and second spaced-apart conveyors, wherein the stabilizing bars extending between and are secured to the carriers of the corresponding conveyor.

Clause 19. The system of any one of clauses 14 to 18, wherein each stabilizing bar comprises a recessed central region that is (i) disposed between the carriers of the corresponding conveyor and (ii) provides clearance for at least the subset of the plates of the corresponding conveyor when in an expanded condition.

Clause 20. The system of any one of clauses 14 to 19 further comprising one or more motors operable to activate the first and second spaced-apart conveyors, wherein speeds of the one or more motors is adjustable to increase or decrease the force of the plates acting on the formed product.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A tractor conveyor comprising:
a first carrier movable along a first drive;
a second carrier (i) movable along a second drive and (ii) spaced-apart from the first carrier; and
a plurality of plates, each plate of the plurality of plates extending between each of the first and second carriers, the plurality of plates operable to engage and transport a formed product, and at least a subset of the plurality of plates comprising an elasticity such that at least the subset of the plurality of expand and conform to an outer contour of the formed product in response to engagement with the formed product.

2. The tractor conveyor of claim 1, wherein the elasticity of at least the subset of the plurality of plates is adjustable.

3. The tractor conveyor of claim 1 further comprising buckles, and wherein each plate of at least the subset of the plurality of plates engages one of the buckles.

4. The tractor conveyor of claim 3, wherein each plate of at least the subset of the plurality of plates is adjustable along a corresponding buckle to adjust the elasticity of the plates.

5. The tractor conveyor of claim 1 further comprising tabs extending from the first and second carriers, wherein each plate of the plurality of plates is secured to one of the tabs positioned on the first carrier and to one of the tabs positioned on the second carrier.

6. The tractor conveyor of claim 5 further comprising a plurality of brackets, wherein each bracket of the plurality of brackets extends between the first and second carriers, is secured to one of the tabs positioned on the first carrier, and is secured to one of the tabs positioned on the second carrier.

7. The tractor conveyor of claim 6, wherein each bracket of the plurality of brackets comprises a recessed central region that is (i) disposed between the first and second carriers and (ii) provides clearance for the plurality of plates when in an expanded condition.

8. A method comprising:
engaging conveyor plates with a formed product;
deforming the conveyor plates upon engagement with the formed product to conform to an outer contour of the formed product; and
transporting the formed product via the conveyor plates while the conveyor plates are in a deformed state.

9. The method of claim 8 further comprising adjusting an elasticity of the conveyor plates prior to engaging the conveyor plates with the formed product.

10. The method of claim 8 further comprising cooling the formed product along the conveyor plates.

11. The method of claim 8 further comprising returning the conveyor plates to a non-deformed state upon the conveyor plates releasing the formed product.

12. The method of claim 11, wherein the formed product is released from the conveyor plates into a cooling tank.

13. The method of claim 8, wherein the conveyor plates receive the formed product from a die while the formed product is in a heated state.

14. The method of claim 8, wherein an elasticity of the conveyor plates is less than an elasticity of the formed product.

15. A system comprising:
a die operable to form a product from molten material; and
first and second spaced-apart conveyors each comprising plates extending between opposing lateral sides of the first and second spaced-apart conveyors, wherein the plates (i) are operable to engage and pull the formed product away from the die and (ii) at least a subset of the plates comprise an elasticity such that at least the subset of the plates expand and conform to an outer contour of the formed product.

16. The system of claim 15, wherein the first and second spaced-apart conveyors comprise movable carriers disposed along the opposing lateral sides of the first and second spaced-apart conveyors.

17. The system of claim 16, wherein the plates of each of the first and second spaced-apart conveyors extend between and are secured to the carriers of the corresponding conveyor.

18. The system of claim 16 further comprising stabilizing bars secured to the movable carriers of each of the first and second spaced-apart conveyors, wherein the stabilizing bars extending between and are secured to the carriers of the corresponding conveyor.

19. The system of claim 18, wherein each stabilizing bar comprises a recessed central region that is (i) disposed between the carriers of the corresponding conveyor and (ii) provides clearance for at least the subset of the plates of the corresponding conveyor when in an expanded condition.

20. The system of claim 15 further comprising one or more motors operable to activate the first and second spaced-apart conveyors, wherein speeds of the one or more motors is adjustable to increase or decrease a force of the plates acting on the formed product.
